(19) United States
(12) Patent Application Publication
(10) Pub. No.: US 2010/0108583 A1
(43) Pub. Date: May 6, 2010

(54) INSTALLATION SYSTEM WITH RECYCLING CAPABILITIES FOR ALKALINE WATER IONIZER MACHINE OR A REVERSE OSMOSIS SYSTEM

(76) Inventor: Jalil I. Badran, Long Beach, CA (US)

Correspondence Address: STETINA BRUNDA GARRED & BRUCKER, 75 ENTERPRISE, SUITE 250, ALISO VIEJO, CA, 92656, US

(21) Appl. No.: 12/264,448

(22) Filed: Nov. 4, 2008

(51) Int. Cl. B01D 35/157

(52) U.S. Cl. 210/119; 210/137; 210/117

(57) ABSTRACT

An installation kit for an alkaline water ionizer unit or reverse osmosis unit may comprise a valve having two separate flow paths. The first flow path provides tap water to the alkaline water ionizer unit or the reverse osmosis unit. The second flow path connects to a “by-product” water outlet of the alkaline water ionizer unit or the reverse osmosis unit. The “by-product” water may be drained to the kitchen sink or stored in a storage tank for later use.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to an installation system with recycling capabilities for an alkaline water ionizer machine.

Drinking water is very important to the health of a person. Unfortunately, tap water lacks certain characteristics that may be beneficial for people. By way of example and not limitation, tap water does not typically have “good” oxidation reduction potential (i.e., antioxidants). Additionally, tap water appears to be acidic and not efficient at hydrating a person. Accordingly, water ionization units have been developed to produce water that has “good” oxidation reduction potential, is alkaline and able to hydrate a person's body better than typical tap water. These systems are generically known as an Alkaline Water Ionizer Machine. Such a machine is currently being manufactured and sold by Enagic USA, Inc. The Enagic SD501 ionizer unit (aka Kangen Water unit) receives tap water and processes tap water to output water that has “good” oxidation reduction potential, is alkaline and able to hydrate the body better. Moreover, the output of the Kangen Water unit emulsifies and breaks down oils and pesticides better compared to tap water.

To install an alkaline water ionizer unit or a unit similar to the Kangen Water unit, the inlet of the alkaline water ionizer unit is fluidically connected to the nozzle end of a water faucet of a kitchen sink by way of a diverter. In particular, there may be a hose or tube that runs from the alkaline water ionizer unit, along the top of the kitchen counter to the base of the kitchen faucet then along the neck or spout thereof where it attaches the diverter. This set up obstructs the kitchen faucet, restricts the mobility of the kitchen faucet, and makes use of the kitchen faucet cumbersome. Typically, the diverter operates by rotating a lever on its side to divert water from the kitchen faucet to the alkaline water ionizer unit. Unfortunately, the kitchen faucet cannot be used to simultaneously (1) supply water to the alkaline water ionizer unit and (2) supply water for normal kitchen use such as washing dishes. The diverter also complicates use of the kitchen faucet in that the diverter is made from plastic and frequently loosens and falls off of the kitchen faucet.

The alkaline water ionizer unit may additionally have two outlet tubes wherein the first outlet tube produces “good” water and the second outlet produces “by-product” water. The “good” water is drinkable. The “by-product” water is not drinkable due to its high acidity and is typically drained in the kitchen sink. In particular, the by product water hose runs from the alkaline water ionizer unit along the kitchen counter and attaches to a plastic arm with a suction cup that sticks to the counter or the inside wall of the kitchen sink to drain the “by-product” water into the kitchen sink. Accordingly, there are a plurality of exposed hoses on the kitchen work space cluttering the kitchen tabletop. Although the benefits of water produced by the alkaline water ionizer unit may be great, the installation of the alkaline water ionizer unit may not be aesthetically pleasing.

During operation of the Kangen Water unit, a significant amount of “by-product water” is drained and wasted to produce “good” water or Kangen water. For example, one gallon of “by-product” water may be drained to produce two gallons of “good” water. The “by-product” water is drained into the kitchen sink. Accordingly, a significant amount of water is wasted to produce the “good” water.

Accordingly, there is a need in the art for an improved installation kit to make installation of the alkaline water ionizer unit more aesthetically pleasing and also for reclaiming wasted “by-product” water.

### BRIEF SUMMARY

The installation kit for an alkaline water ionizer unit described herein addresses the deficiencies identified above, described below and those that are known in the art. Although the installation kit and other aspects (e.g., system for reclaiming water) are described herein in relation to an alkaline water ionizer unit. The installation kit and the other aspects may be applied to a reverse osmosis system.

The installation kit may comprise a two way faucet for routing tap water through the faucet body and into the alkaline water ionizer unit. From the alkaline water ionizer unit, two hoses, one for “good” water and the other for “by-product” water, may extend out of the alkaline water ionizer unit. The “by-product” water hose of the unit may be connected to a fluid flow path that leads to either a storage tank or the drain of the kitchen sink. When an on-off valve is switched to the “on” position, the “by-product” water flows into the storage tank 18 for later use. When the on-off valve is closed, the “by-product” water is bypassed into the drain of the kitchen sink.

More particularly, the two way faucet for delivering water may deliver water to an inlet of a alkaline water ionizer unit. The two way faucet may also receive by product water produced by the alkaline water ionizer unit. The two way faucet may comprise a device body, a first fluidic pathway, a second fluidic pathway and a valve for regulating water flow. The first fluidic pathway, the second fluidic pathway and the valve may be disposed within the two way faucet body. The first fluidic pathway may have an inlet connectable to a water source. The first fluidic pathway may also have an outlet connectable to the inlet of the alkaline water ionizer unit. The second fluidic pathway may have an inlet connectable to a by product outlet of the alkaline water ionizer unit. For example, the inlet may be a tube with a barbed end portion. The by-product outlet may be a hose that slides over the barbed tube. The second fluidic pathway may also have an outlet. The valve may be disposed between the inlet and outlet of the first fluidic pathway for regulating water flow through the first fluidic pathway. The valve may be a ceramic disc valve. One benefit of the two way faucet for installing the alkaline water ionizer unit is that the kitchen faucet may be used normally to wash dishes while contemporaneously supplying water to the alkaline water ionizer unit. Additionally, since the installation device is not directly mounted to the kitchen faucet, the kitchen faucet retains its mobility. There are no loose hoses that interfere with use of the kitchen faucet. Additionally, the two way faucet for installing the alkaline water eliminates the above the counter drain system for the by product water.

It is contemplated that the inlet of the second fluidic pathway may swivel with respect to the device body. The inlet of the second fluidic pathway and the outlets of the first and second fluidic pathways may have barbs for connecting to tubes. The inlet of the first fluidic pathway may be threaded.

A system for reclaiming by product water from an alkaline water ionizer unit is also disclosed herein. The system may comprise a two way faucet and a diverter valve. The two way faucet may be for the purposes of delivering water to the alkaline water ionizer unit and receiving by product water from the alkaline water ionizer unit. The two way faucet may comprise an outlet through which by product water of the alkaline water ionizer unit flows. The diverter valve may be connected to the outlet of the second fluidic pathway. The diverter valve may be traversable between first and second positions. At the first position, the diverter valve may be closed and the water may flow through a first outlet of the diverter. At the second position, the diverter valve may be open and the water may flow through the second outlet of the diverter.

It is contemplated that the reclaim tank may be in fluid communication with the second outlet of the diverter valve. Also, it is contemplated that the first outlet of the diverter valve may be connected to a drain of a kitchen sink.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram of an installation device for installing an alkaline water ionizer unit and a diverter device for reclaiming “by-product” water from the alkaline water ionizer unit;

FIG. 2 is a cross sectional view of the installation device;

FIG. 3 is an exploded perspective view of a faucet attached to the tabletop shown in FIG. 1;

FIG. 4 is an exploded perspective view of the internals of the faucet shown in FIG. 1; and

FIG. 4A is a top view of a retaining clip.

### DETAILED DESCRIPTION

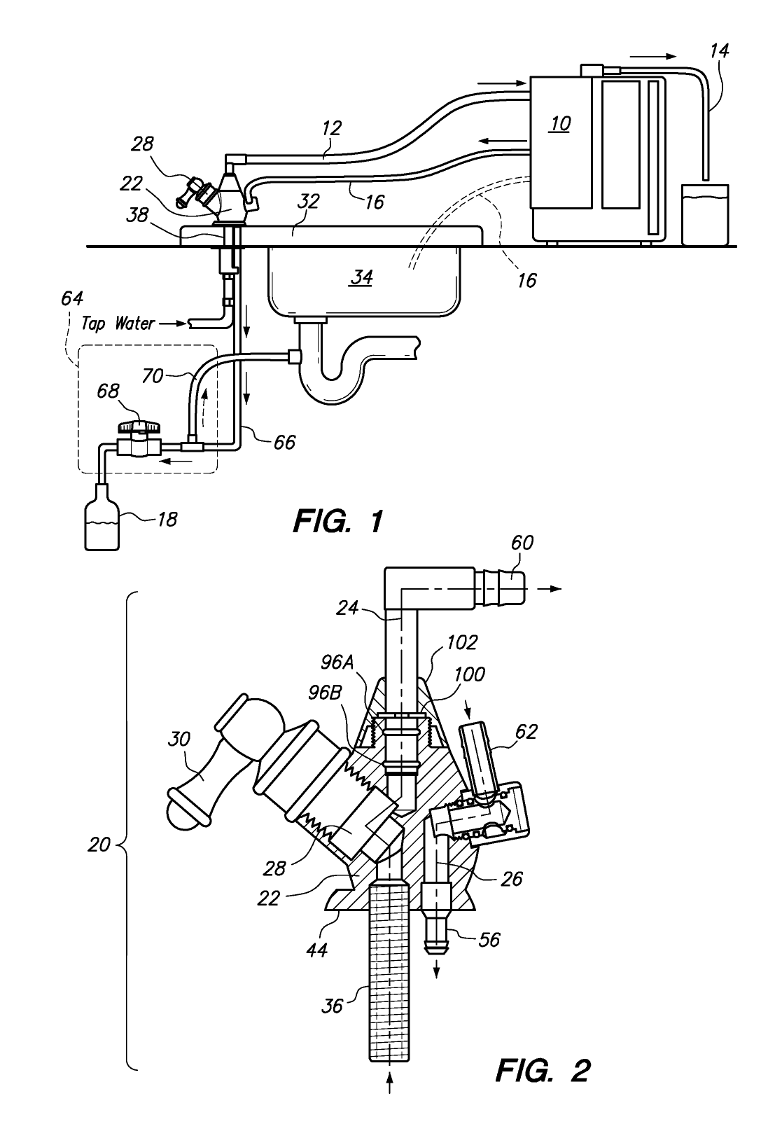

Referring now to FIG. 1, the alkaline water ionizer unit 10 has an inlet hose 12 for receiving tap water. The alkaline water ionizer unit 10 additionally has two outlet hoses 14, 16 which are the “good” water outlet hose 14 and the “by-product” water outlet hose 16. When the tap water is introduced into the alkaline water ionizer unit 10 via the inlet hose 12, the alkaline water ionizer unit 10 processes the tap water. The alkaline water ionizer unit 10 produces “good” water which is output through the “good” water outlet hose 14. The “good” water is the water which is primarily drinkable by the household residence. The alkaline water ionizer unit 10 produces the “by-product” water which flows out of the “by-product” water outlet hose 16. This “by-product” water may be drained into the kitchen drain or diverted to a storage tank 18 for later use. The “by-product” water that is stored in the storage tank 18 is not necessarily undrinkable water. However, the “by-product” water may have other beneficial uses which include cleaning and other additional uses.

The installation system for the alkaline water ionizer unit 10 may comprise a faucet 20 (see FIG. 2). The faucet 20 may have a faucet body 22 with two separate fluid flow paths 24 and 26. The flow path 24 feeds tap water to the alkaline water ionizer unit 10. The “by-product” water of the alkaline water ionizer unit 10 is connected to the flow path 26. A ceramic disc valve 28 may be disposed within the flow path 24 to regulate the amount of tap water flowing into the alkaline water ionizer unit 10. The ceramic disc valve 28 may have a handle 30 for closing or opening the ceramic disc valve 28 fully open, fully close or at an intermediate position. It is also contemplated that other types of flow regulators may be implemented instead of ceramic disc valves such as butterfly valves, ball valves, etc.

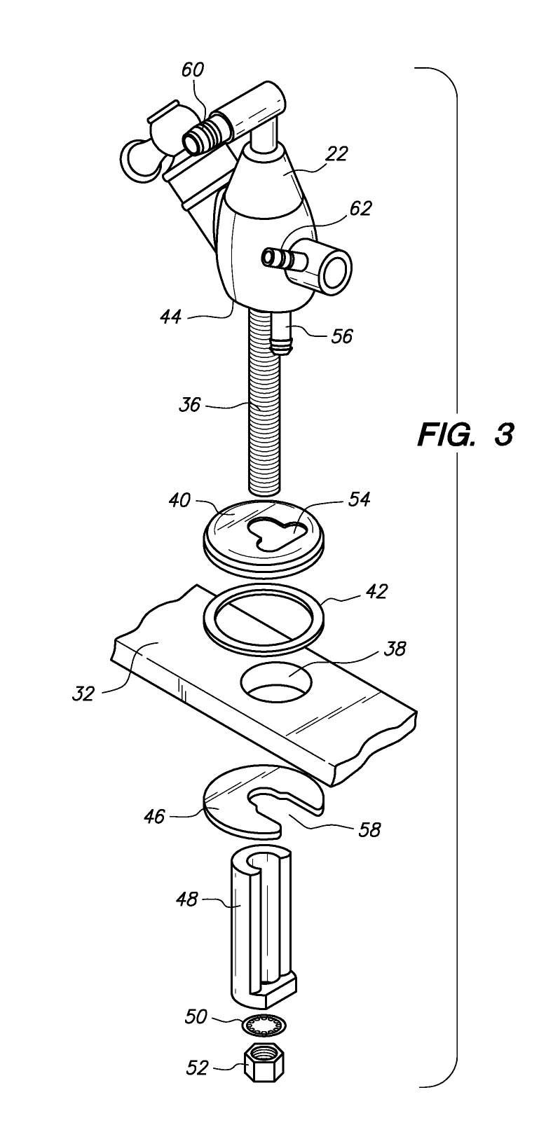

The faucet body 22 may be mounted to the tabletop 32 of the kitchen sink 34, as shown in FIG. 3. The faucet body 22 may have a threaded stud 36 for attaching the faucet body 22 to the tabletop 32 of the kitchen sink 34. The threaded stud 36 may be disposed within a hole 38 fabricated in the tabletop 32 of the kitchen sink 34. A washer 40 and a seal 42 may be disposed between the bottom surface 44 of the faucet body 22 and the tabletop 32 of the kitchen sink 34. The threaded stud 36 may protrude through the hole 38 and extend under the tabletop 32 of the kitchen sink 34. A washer 46, spacer 48 and lock washer 50 may be disposed below the tabletop 32 and about the threaded stud 36. A nut 52 may be threaded onto the threaded stud 36 to secure the faucet body 22 to the tabletop 32 of the kitchen sink 34. The washer 40 may have a T-shaped aperture 54 for receiving the threaded stud 36 as well as an outlet 56 of the flow path 26. The washer 40 may be chrome plated for providing an aesthetically pleasing device. The faucet body 22 may rest on the washer 40 and cover the entire aperture 54. The washer 40 may cover the entire aperture 38. The seal 42 may be disposed completely under the washer 40 about its periphery. The seal 42 may provide a water seal to prevent water on the tabletop 32 of the kitchen sink 34 from seeping into the hole 38. The washer 46 may have a slot for receiving the threaded stud 36 and the outlet 56 of the flow path 26. The slot 58 provides for easy removal and easy insertion of the washer 46 onto the threaded stud 36. The spacer 48, lock washer 50 and nut 52 do not have to be removed for removal or mounting of the washer 46. Since the threaded stud 36 and the outlet 56 are positioned close to each other, the spacer 48 shown in FIG. 3 provides additional space for the connection of various tubes to the threaded stud 36 and the outlet 56.

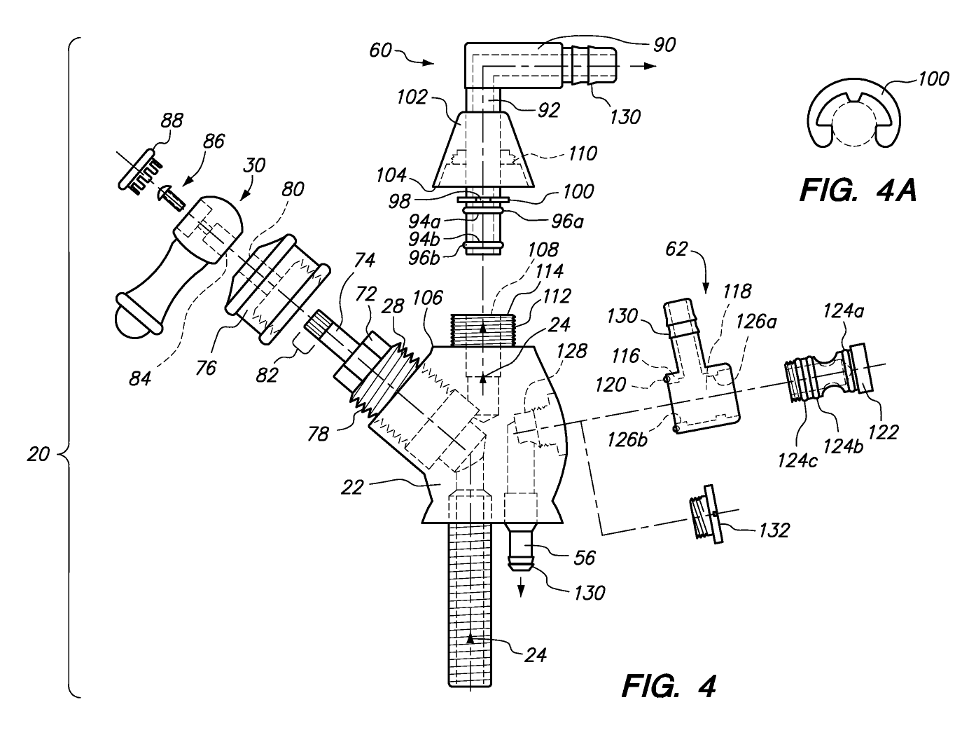

Once the faucet body 22 is attached to the tabletop 32 of the kitchen sink 34, the tap water source is connected to the threaded stud 36. The threaded stud 36 is hollow (see FIG. 4) and forms the fluid flow path 24 for providing the tap water to the alkaline water ionizer unit 10. The tap water source may be connected to the threaded stud 36 through various fittings that are known in the art or developed in the future. The inlet hose 12 may be connected to the outlet 60 for completing the fluid flow path 24 from the tap water source to the alkaline water ionizer unit 10. The ceramic disc valve 28 may be used to regulate the amount of water flowing to the alkaline water ionizer unit 10. The “by-product” water outlet hose 16 may be connected to the inlet 62 of the fluid flow path 26. The outlet 56 of the fluid flow path 26 may be in fluid communication with a diverter system 64 (see FIG. 1). A primary hose 66 may be connected to the outlet 56 and in fluid communication with the storage tank 18. The primary hose 66 may be connected to an on-off valve 68. The on-off valve 68 may be a ball valve, butterfly valve, or any other valve capable of closing off flow through the primary hose 66. In the orientation shown in FIG. 1, the on-off valve 68 permits water to flow through the primary hose 66 and into the storage tank 18. When the on-off valve 68 is rotated to a closed position, “by-product” water cannot flow to the storage tank 18. Pressure is built up within the primary hose 66 and forces water through the bypass hose 70 (see FIG. 1) which is connected to the primary hose 66. The bypass hose 70 may be tapped into the kitchen sink drain via methods known in the art. When the on-off valve 68 is in the closed position, the “by-product” water 16 is now drained as waste water. The diverter system 64 permits the user to open the on-off valve 68 to collect “by-product”water in storage tank 18 for later use or to close the on-off valve 68 to drain the “by-product” water into the kitchen sink drain.

The installation system described above provides an aesthetically pleasing installation of the alkaline water ionizer unit 10. The mobility of the kitchen faucet is not impaired. Also, the kitchen faucet can be used independent of whether water is supplied to the alkaline water ionizer unit. Also, it provides a diverter system 64 for providing the option to store “by-product” water for later use or to drain the “by-product” water in the kitchen sink.

Referring now to FIG. 4, the faucet 20 may include the faucet body 22. The ceramic disc valve 28 may be threadingly engaged to the faucet body 22. More particularly, the faucet body 22 may have a through hole which extends from a side of the faucet body 22 and intersects the fluid flow path 24. The ceramic disc valve 28 is threaded into such through hole. A water tight seal is formed between the threads of the ceramic disc valve 28 and the threads of the through hole by any means known in the art or developed in the future. The ceramic disc valve 28 may be threaded into the through hole with the assistance of a wrench applied to a hex portion 72. A knurled post 74 may extend from the hex portion 72. The knurled post 74 may be rotated clockwise or counterclockwise to open or close the ceramic disc valve 28. When the ceramic disc valve 28 is in the open position, tap water is permitted to flow from the source to the alkaline water ionizer unit 10 through fluid flow path 24. When the ceramic disc valve 28 is in the closed position, fluid flow through the fluid flow path 24 is stopped. The knurled post 74 may also be positioned at an intermediate position between fully open and fully closed such that a metered amount of tap water flows through the fluid flow path 24. A protective cap 76 may be threaded over the hex portion 72 and onto the threads 78 of the ceramic disc valve 28. The knurled post 74 may protrude out through an aperture 80 of the protective cap 76. The knurled portion 82 may extend out of the protective cap 76. A base portion of the handle 30 may have a knurled cavity 84 which is sized and configured to mate with the knurled portion 82 of the knurled post 74. Upon engagement, the handle 30 is operative to rotate the knurled post 74 in the clockwise direction or the counterclockwise direction. To insure that the handle 30 remains secured to the knurled post 74, a screw 86 may be inserted through the base portion of the handle 30 and attached to the knurled post 74. The head of the screw 86 may be seated within the handle 30. Once the screw 86 is tightened onto the knurled post 74, the handle 30 cannot be pulled off of the knurled post 74. A cover 88 may be frictionally engaged to the handle 30 to hide the head of the screw 86.

The outlet 60 may be an elbow fitting. The outlet 60 may have a first portion 90 which is generally perpendicular to a second portion 92. The first portion 90 may swivel three hundred sixty degrees about the second portion 92. The second portion 92 may have two o-ring grooves 94a, b. O-rings 96a, b may be disposed about the o-ring grooves 94a, b. The second portion 92 may additionally have a retaining clip groove 98. A retaining clip 100 (see FIG. 4A) is removably insertable onto the retaining clip groove 98. A conically shaped protective cover 102 may be slidably disposed about the second portion 92 above the retaining clip groove 98. The outer periphery 104 of the conical protective cover 102 may be flush with the outer periphery 106 of the faucet body 22 such that the conical protective cover 102 provides an aesthetically pleasing appearance.

When the second portion 92 is inserted into the aperture 108 of the faucet body 22, the o-rings 96a, b provide a water tight seal. The retaining clip 100 limits the amount that the second portion 92 may be inserted into the aperture 108 of the faucet body 22. The threads 110 of the conical protective cover 102 may be threaded onto the threads 112 of the faucet body 22. The retaining clip 100 is disposed between the conical protective cover 102 and the upper end 114 of the faucet body 22. The outlet 60 may slide up and down but is limited in movement due to the retaining clip 100 being sandwiched between the conical protective cover 102 and the upper end of the faucet body 22.

The inlet 62 may comprise an outer housing 116. The outer housing 116 may swivel three hundred sixty degrees about post 122. The outer housing 116 may define an inner chamber 118. A distal end of the outer housing 116 may have an o-ring 120 providing a water tight seal against the faucet body 22. The post 122 may be inserted through the outer housing 116. The post 122 may have a first o-ring 124 which is sealed against a first raised surface 126a of the outer housing 116. The post 122 may additionally have a second o-ring 124b which is sealed against a second raised surface 126b of the outer housing 116. A third o-ring 124c may extend out of the outer housing 116. The o-ring 124c engages an inner surface of the aperture 128 of the faucet body 22. The o-ring 120 rests against the exterior surface of the faucet body 22. These o-rings 120 and 124c provide a water tight seal against leakage of water as water flows through the inlet 62 and the outlet 56.

In an aspect of the faucet 20, referring to FIG. 4, the fluid flow path 26 may be rendered inoperative in the event that a home owner or other decision maker desires to have the “by-product” water outlet hose 16 drain into the kitchen sink instead of through the fluid flow path 26. To this end, the post 122 may be removed from the faucet body 22. Additionally, the outer housing 116 is detached from the faucet body 22. A cap 132 may be screwed into the aperture 128 of the faucet body 22. The “by-product” water hose 16 may drain directly into the sink as shown by the dash lines in FIG. 1.

Appropriate hoses, tubes, etc. may be attached to the inlets and outlets 36, 62, 60, 56 for the purposes of routing water to and from the alkaline water ionizer unit 10. Any means known in the art or developed in the future may be used to connect the hoses, tubes, etc. to the respective inlets and outlets 36, 62, 60, 56. For example, the outlets 60, 56 may have barbs 130. Tubes or hoses may be slipped over the outlets 60, 56. The inner diameter of the tubes and hoses may be sized and configured to frictionally fit over the outlets 60, 56. The barbs 130 prevent the tube and holes from slipping off of the outlets 60, 56. Additionally, the inner surface of the tube and the outer surface of the outlets 60, 56 as well as the barbs 130 provide a water tight seal between the outlets 60, 56 and the tube or hose. Similarly, the inlet 62 may also have barbs 130. Tubes or hoses may be slipped over the inlet 62. The barbs 130 prevent the tube or hose from slipping off of the inlet 62. Also, the barbs 130 and the tight fit between the inner diameter of the tube or hose and the exterior surface of the inlet 62 form a water tight seal. The inlet 36 of the fluid flow path 24 may be a threaded stud 36. The threaded stud may be hollow and be connected to the fluid flow path 24 within the faucet body 22. A hose or tube from the tap water source may be connected to the threaded stud or inlet 36 for providing tap water to the alkaline water ionizer unit 10 via known fittings in the art or developed in the future.

The fluid flow paths 24, 26 may be sized to allow full flow of water through the alkaline water ionizer unit 10 from the tap water source and also to allow full flow of “by-product” water from the alkaline water ionizer unit 10 to the outlet 56 of the faucet 20. The ceramic disc valve 28 may limit or restrict the flow rate of tap water flowing through to the alkaline water ionizer unit 10. However, the sizes of the inlets and outlets 36, 62, 60, 56 are preferably sized to be sufficiently large to handle the flow of tap water through the system. By way of example and not limitation, the inlet 36, outlet 60 and the inlet 62 may have an inner diameter of approximately one quarter inch (¼″). The outlet 56 may have an inner diameter of five sixteenths of an inch ( 5/16″).

It is contemplated that the exterior surfaces of the conical protective cover 102, the outlet 60, the faucet body 22, the post 122 and the outer housing 116 have a chrome finish, satin nickel finish or other aesthetically pleasing finish. Preferably, the finish is resistant to corrosion.

The installation system described above may be used to install the Kangen water unit or other alkaline water ionizer units that are in the marketplace or developed in the future. Additionally, the installation system described above may be used to install a reverse osmosis system. In particular, the reverse osmosis system is provided with tap water through an inlet hose. The reverse osmosis system has two outlet hoses similar to the alkaline water ionizer unit which are the “good” water outlet hose and the “by-product” water outlet hose. The various aspects discussed herein in relation to the alkaline water ionizer system may be used to install the reverse osmosis system. By way of example and not limitation, the alkaline water ionizer unit discussed above may be replaced with the reverse osmosis system. Tap water may be routed to the reverse osmosis system through the first fluid path 24 as described above in relation to the alkaline water ionizer unit. The reverse osmosis system produces “by product” water which may be routed through the second fluid path 26 as described above in relation to the alkaline water ionizer unit. Alternatively, the by product water of the reverse osmosis system may be directly drained into the sink as described above in relation to the alkaline water ionizer unit. Additionally, the diverter system may be installed under the sink or at another convenient location to divert the “by product” water of the reverse osmosis system to the storage tank or to the kitchen sink drain.

The above description is given by way of example, and not limitation. Given the above disclosure, one skilled in the art could devise variations that are within the scope and spirit of the invention disclosed herein, including various ways of connecting the hoses/tubes to the inlets and outlets of the faucet body 22. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A device for delivering water to an alkaline water ionizer unit or a reverse osmosis unit having an inlet and receiving a by product from the alkaline water ionizer unit or the reverse osmosis unit, the device comprising:
a device body;
a first fluidic pathway within the device body, the first fluidic pathway having an inlet connectable to a water source and an outlet connectable to the inlet of the alkaline water ionizer unit or the reverse osmosis unit;
a second fluidic pathway within the device body, the second fluidic pathway having an inlet connectable to a by product outlet of the alkaline water ionizer unit or the reverse osmosis unit and an outlet; and
a valve disposed between the inlet and outlet of the first fluidic pathway for regulating water flow through the first fluidic pathway.

2. The device of claim 1 wherein the inlet of the second fluidic pathway swivels with respect to the device body.

3. The device of claim 1 wherein the valve is a ceramic disc valve.

4. The device of claim 1 wherein the inlet of the second fluidic pathway and the outlets of the first and second fluidic pathways have barbs for connecting to tubes.

5. The device of claim 1 wherein the inlet of the first fluidic pathway is threaded.

6. A system for reclaiming by product water from an alkaline water ionizer unit or a reverse osmosis unit, the system comprising:
a device for delivering water to the alkaline water ionizer unit or the reverse osmosis unit and receiving by product water from the alkaline water ionizer unit or the reverse osmosis unit, the device comprising an outlet through which the by product exits the device; and
a diverter valve connected to the outlet of the second fluidic pathway and having first and second positions, the diverter valve having a first outlet through which the by product of the alkaline water ionizer unit or the reverse osmosis unit flows when the diverter is in the first position and a second outlet through which the by product of the alkaline water ionizer unit or the reverse osmosis unit flows when the diverter is in the second position.

7. The system of claim 6 further comprising a reclaim tank in fluid communication with the second outlet of the diverter valve.

8. The system of claim 6 wherein the first outlet of the diverter valve is connectable to a drain of a kitchen sink.

9. The system of claim 6 wherein the diverter valve is a ball valve.

10. A device for installing an alkaline water ionizer unit or reverse osmosis unit into a kitchen sink, the device comprising:
a device body;
a first fluidic pathway within the device body, the first fluidic pathway having an inlet connectable to a water source and an outlet connectable to an inlet of the alkaline water ionizer unit or the reverse osmosis unit;
a valve disposed between the inlet and outlet of the first fluidic pathway for regulating water flow through the first fluidic pathway;
a second fluidic pathway within the device body, the second fluidic pathway having an inlet and an outlet, the inlet being connectable to a by product outlet of the alkaline water ionizer unit or the reverse osmosis unit; and
a cover attached to the inlet of the second fluidic pathway when the by product outlet of the alkaline water ionizer unit or the reverse osmosis unit is disconnected from the inlet of the second fluidic pathway.

11. The device of claim 10 further comprising a barbed tube removeably attachable to the inlet of the second fluidic pathway.

12. The device of claim 10 wherein the cover is snapped onto the inlet of the second fluidic pathway.
